(19) United States
(12) Patent Application Publication
(10) Pub. No.: US 2019/0050886 A1
(43) Pub. Date: Feb. 14, 2019

(54) LOCATION-AWARE LOYALTY PROGRAM APPORTIONING

(71) Applicant: POINTS2MILES, LLC, Pharr, TX (US)

(72) Inventors: Nitin KASAN, Edinburg, TX (US); Vinod KASAN, Pharr, TX (US); Anand PATEL, Suwanee, GA (US)

(21) Appl. No.: 16/058,764

(22) Filed: Aug. 8, 2018

Related U.S. Application Data
(60) Provisional application No. 62/543,356, filed on Aug. 9, 2017.

(51) Int. Cl. G06Q 30/02; H04L 29/06; G06Q 50/00

(52) U.S. Cl. CPC G06Q 30/0226; G06Q 50/01; H04L 63/083

(57) ABSTRACT

In one implementation, a method is disclosed for location-aware apportioning of points in a loyalty program offered by a provider. Data indicative of a current geolocation of a mobile device is received at a mobile app executing on a mobile device. User input corresponding to a service location of a provider offering a loyalty program is received via an interface associated with the mobile app. A distance is determined between the current geolocation and a geolocation of the service location. The distance is converted into points offered by the provider for completing a transaction at the service location using an apportioning function associated with the loyalty program. The interface is updated to present a loyalty program offer that includes the points.

### PRIORITY CLAIM

The present application claims priority under 35 U.S.C. § 119(e) to U.S. Provisional Patent Application No. 62/543,356 that was filed on Aug. 9, 2017 and entitled “Location-Aware Loyalty Program Apportioning,” the contents of which is incorporated herein by reference as if reproduced in its entirety.

### TECHNICAL FIELD

The present invention relates generally to loyalty programs, although not limited thereto. More specifically, the present invention relates to techniques for apportioning points in a loyalty program.

### BACKGROUND

Providers of goods or services may offer loyalty programs to consumers as an incentive to purchase their goods or services instead of comparable offerings by their competitors. Through these loyalty programs, consumers earn points (or credits) for purchasing goods or services from the providers. Consumers may subsequently redeem any points earned through the loyalty program for rewards offered by the providers, such as discounts on future purchases, gift certificates, free products or services, and the like. As an example, providers of hotel or other accommodation services may offer a loyalty program to consumers as an incentive to book rooms at their hotels instead of booking rooms at hotels operated by their competitors.

### SUMMARY

Embodiments of the present invention provide systems, methods, and computer-readable storage media for location-aware apportioning of points in a loyalty program offered by a provider. In an embodiment, a method includes receiving, at a mobile app executing on a mobile device, data indicative of a current geolocation of the mobile device. User input corresponding to a service location of a provider offering a loyalty program is received via an interface associated with the mobile app. A distance is determined between the current geolocation and a geolocation of the service location. The distance is converted into points offered by the provider for completing a transaction or purchase at the service location using an apportioning function associated with the loyalty program. The interface is updated to present a loyalty program offer that includes the points.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The accompanying drawings, which are incorporated in and constitute a part of this specification, illustrate various embodiments of the present invention and, together with the general description of the invention given above, and the detailed description of the embodiments given below, serve to explain the embodiments of the invention. In the drawings, like reference numerals are used to indicate like parts in the various views.

FIG. 1 is a block diagram of an example operational environment that is suitable for implementing aspects of the present invention.

FIG. 2 is an example of an interface displaying a launch (splash) screen.

FIG. 3 is an example of an interface displaying a sign-up screen.

FIG. 4 is an example of an interface displaying a log-in screen.

FIG. 5 is an example of an interface displaying a welcome (home/dashboard) screen.

FIG. 6 is a flow-chart illustrating an example of a method for location-aware apportioning of points in a loyalty program offered by a provider.

FIG. 7 is a flow diagram depicting an example process for confirm or verify completion of transactions associated with loyalty program offers, and accordingly apportioning points to loyalty program accounts.

FIG. 8 is a block diagram of an example computing environment suitable for use in implementing embodiments of the invention.

### DETAILED DESCRIPTION

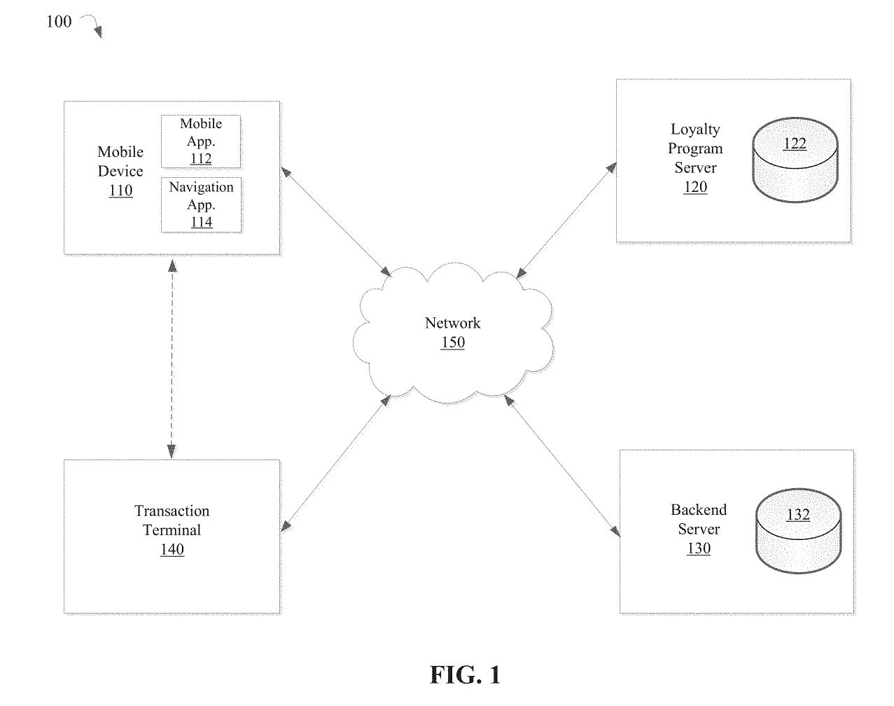

FIG. 1 is a block diagram depicting an operating environment that is suitable for implementing embodiments of the present invention, which is generally referenced as operating environment 100. In general, operating environment 100 represents the various components involved in implementing a loyalty program offered by a provider. As depicted, operating environment 100 includes mobile device 110, loyalty program server 120, backend server 130, transaction terminal 140, and network 150.

Mobile device 110 includes circuitry configured to effectuate various software applications (“apps”), such as mobile app 112 and navigation app 114. Mobile device 110 may take on a variety of forms, such as a laptop computer, a tablet, a mobile phone, a personal digital assistant (PDA), or any other computing device that is not substantially fixed in a particular geographic location and is communicatively coupled to operating environment 100.

Mobile app 112 is generally configured to enable a user to participate in the loyalty program using mobile device 110. In operating environment 100, the user interacts with mobile app 112 via an interface that mobile app 112 presents on a display of mobile device 110. Using the interface, the user may submit user input to mobile app 112 for further processing. Mobile app 112 may interact with navigation app 114 to obtain data related to a current geolocation of mobile device 110 and a geolocation of service locations associated with the provider. In an embodiment, navigation app 114 may be implemented using the GOOGLE MAPS app provided by Alphabet, Inc. of Mountain View, Calif. In an embodiment, mobile app 112 natively executes within a runtime environment of an operating system of mobile device 110. In an embodiment, mobile app 112 is a web application that executes within a runtime environment of a web browser operating on mobile device 110.

One skilled in the art will recognize that a mobile application, such as mobile app 112, relates to a client (or front-end) component of a client-server architecture that collectively with a server (or back-end) component provides various functionalities to an end user. In general, the client component consumes resources and/or services that are provided by the server component. To that end, a connection or communication link is established between the client and server components over a network (e.g., network 150). The client and server components exchange data in accordance with a communication protocol governing the connection. Examples of such communication protocols include: hypertext transfer protocol (“HTTP”), file transfer protocol (“FTP”), Websocket protocol, user datagram protocol (“UDP”), and the like.

The client component includes one or more processes that are effectuated using a runtime environment of a client-side device (e.g., mobile device 110). Stated differently, the client component resides on the client-side device. The runtime environment of the client device may include: an operating system of the client-side device, a web browser, a web browser plug-in, a mobile application, a JavaScript application, and the like. In an embodiment, the client component of the client-server architecture is retrieved from a server-side device (e.g., loyalty program server 120 and/or back end server 130) hosting the server component of the client-server architecture.

The client component is operative to generate or create interfaces (e.g., graphical user interfaces) that are presented on a display of the client-side device through which data is obtained from and returned to an end user. Data obtained from the user via the interface is sent as a request to the server component of the client-server architecture via application programming interfaces. For example, the client component may receive input from the user via the interface indicative of a request for content. In response to receiving the input, the client component may send that request to the server component to obtain the content.

The server component is effectuated using computing resources provided by a server-side device, such as loyalty program server 120 and/or back end server 130. The server component is operative to serve a response to the client component upon receiving a request from the client component. Continuing with the example above, in response to receiving a request for content from the client-side component, the server-side component would serve a response including the requested content to the client-side component. Upon receiving the response, the client-side component would update a state of the UI based on the content included in the response.

One example of a client-server architecture is how mobile app 112 interacts with loyalty program server 120 via network 150 to participate in the loyalty program. Loyalty program server 120 is generally configured to provide the underlying infrastructure for implementing the loyalty program on behalf of the provider. In implementing the loyalty program, loyalty program server 120 instantiates a web-based interface for communicating data related to the loyalty program. Data related to loyalty account information, apportioning functions, authentication information, and the like may be stored in database structures 122 instantiated on loyalty program server 120.

Backend server 130 is configured to provide computing resources (e.g., processors and computer-readable media) to mobile app 112 for implementing one or more of the functionalities described herein. For example, mobile app 112 may interact with backend server 130 via network 150 to implement an authentication process, a registration process, or a combination thereof, as described in greater detail below. As another example, loyalty program-related profile data and/or authentication information may be stored in database structures 132 instantiated on backend server 130.

Transaction terminal 140 is typically located at a service location of a provider offering a loyalty program. Transaction terminal 140 is generally configured to effectuate a transaction involving a good and/or service offered by the provider. Examples of suitable computing devices for implementing transaction terminal 140 include: a self-service kiosk, a checkout station, a point-of-sale terminal, a desktop computer, a laptop, a tablet, and the like. As seen in FIG. 1, transaction terminal 140 may communicate with mobile device 110 via a network (e.g., network 150). Transaction terminal 140 may also form a device-to-device communication link with mobile device 110 in which transaction terminal 140 and mobile device 110 directly communicate without traversing a network structure (e.g., network 150). For example, transaction terminal 140 may form a device-to-device communication link with mobile device 110 using communication protocols, such as near-field communication, Bluetooth, Bluetooth Low Energy, and the like.

By way of example, if the provider offering the loyalty program is a hotel provider, transaction terminal 140 may be a computing device located in an entrance, reception area, or foyer of a hotel. In this example, transaction terminal 140 is operative to determine whether a reservation record exists in a reservation system for an arriving guest as part of a check-in process. In accordance with a determination that a reservation does exist, transaction terminal 140 is configured to update the reservation record to indicate that the guest has checked in to the hotel. Upon conclusion of the check-in process, the guest is provided access to a hotel room of the hotel. For example, transaction terminal 140 may activate an existing digital key or token residing in memory of a mobile device associated with a guest or transmit a digital key or token to the mobile device upon conclusion of a check-in process.

Network 150 may be configured to communicatively couple mobile device 110, loyalty program server 120, backend server 130, and transaction terminal 140. Network 150 may implemented using any number of networks such as, for example, a local area network (“LAN”), a wide area network (“WAN”), the Internet, a cellular network, a mobile network, or a combination of networks. Such networking environments are commonplace in offices, enterprise-wide computer networks, intranets and the Internet. Accordingly, network 150 is not further described herein.

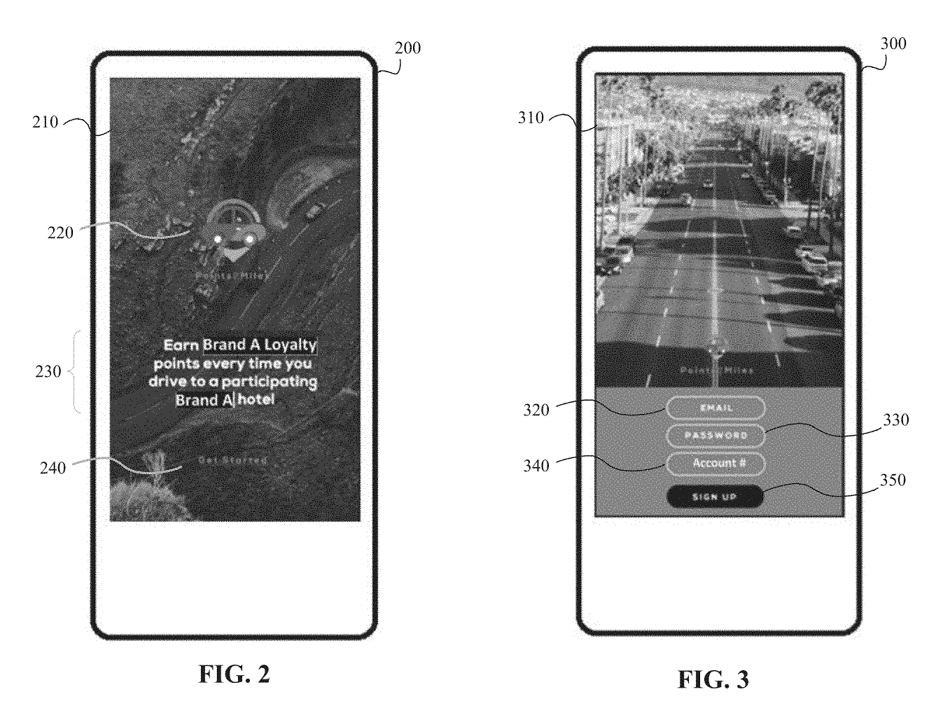

FIGS. 2-5 illustrate example interfaces displayed by a mobile app executing on a mobile device (e.g., mobile app 112 and mobile device 110 of FIG. 1, respectively), in accordance with embodiments of the present invention. Each interface includes a number of interface elements that facilitate user interaction with one or more features of the mobile app. Such interface elements may include input elements, output elements, and input/output elements (“I/O elements”). As used herein, input elements correspond to interface elements that are presented by the mobile app to elicit input from users, such as text input fields, drop down lists, drop down buttons, check boxes, radio buttons, toggles, seek bars, and the like. As used herein, output elements correspond to interface elements that are presented by the mobile app to convey information or data to users, such as toasts, progress bars, message boxes, graphics, text output fields, and the like. As used herein, I/O elements correspond to interface elements that are presented by the mobile app to both elicit input from users and convey information or data to users, such as dialogs, notifications, speech balloons, and the like.

One skilled in the art will recognize that various modifications, additions, and alterations may be made to the example interfaces illustrated by FIGS. 2-5 without departing from the spirit and scope of the present invention. For example, aesthetic or functional considerations may require varying the number of interface elements, the arrangement of interface elements, the size of one or more interface elements, the color of one or more interface elements, the length of a text input field, a background color, a background image, and the like.

FIG. 2 is an example of an interface 210 displaying a splash screen (or launch screen) associated with a mobile app executing on mobile device 200. In an embodiment, interface 210 is presented to users in response to mobile device 200 receiving a request to launch the mobile app. In an embodiment, interface 210 is presented to users in response to mobile device 200 receiving an initial request to launch the mobile app. Interface 210 includes logo 220, text field 230, and link 240 presented on a background image. Logo 220 is an interface element that identifies the mobile app, a source of the mobile app, or a combination thereof to users of the mobile app. In an embodiment, logo 220 is an output element (e.g., an image). In an embodiment, logo 220 is an I/O element (e.g., an icon) configured to direct a web browser executing on mobile device 200 to specific web content that provides additional information regarding the source of the mobile app.

Text field 230 provides users with information regarding the general purpose of the mobile app. In an embodiment, text field 230 is an output element. In an embodiment, text field 230 is an I/O element configured to direct a web browser executing on mobile device 200 to specific web content that provides additional information regarding the mobile app, a provider associated with the mobile app, and/or a loyalty program offered by a provider associated with the mobile app. Link 240 is an input element that causes the mobile app to transition to other interfaces (e.g., interfaces 310, 410, or 510 of FIGS. 3, 4, and 5, respectively) when users interact with link 240.

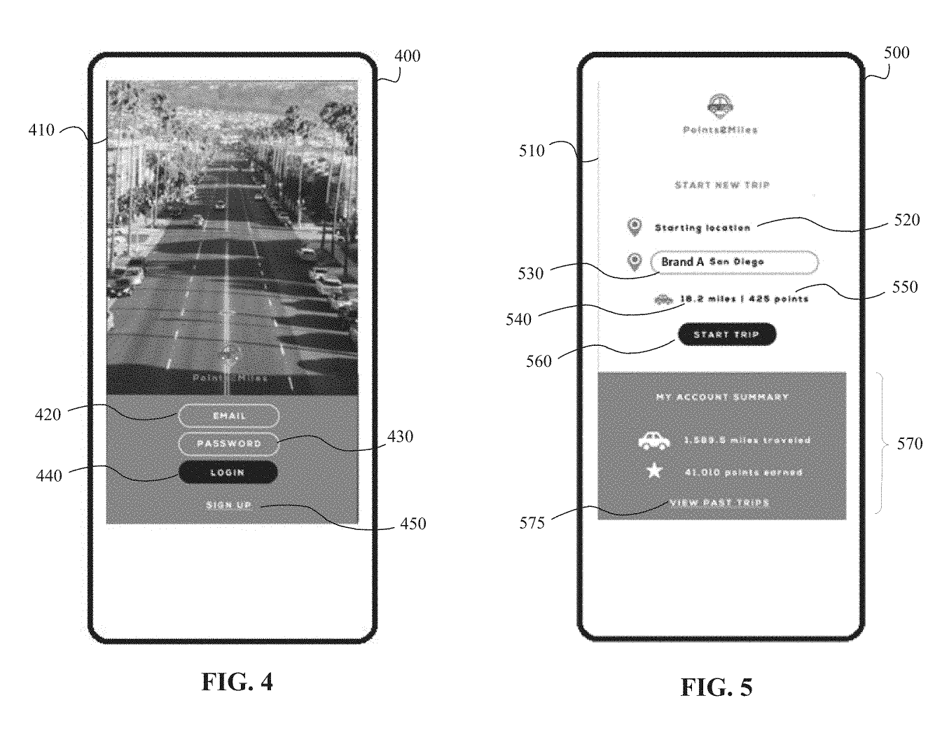

FIG. 3 is an example of an interface 310 displaying a sign-up screen associated with a mobile app executing on mobile device 300. In an embodiment, interface 310 is presented until a user registers with the mobile app. In an embodiment, interface 310 is presented to users upon selection of an interface element requesting a sign-up screen (e.g., link 450 of FIG. 4) presented on other interfaces. Interface 310 enables new users to register with the mobile app by providing sign-up information using first input field 320, second input field 330, and third input field 340. As shown, users are prompted with first input field 320 for providing an email address, second input field 330 for providing a chosen password, and third input field 340 for providing an account number corresponding to a loyalty program account.

Following registration, the email address provided in first input field 320 and the chosen password provided in second input field 330, collectively, serve as authentication information for logging into the mobile app. While this example uses an email address combined with a chosen password as authentication information, one skilled in the art will recognize that other authentication information may be used. For example, the email address may be replaced with an alphanumeric user identifier and an authentication token may be used in lieu of a chosen password. In an embodiment, the authentication information for logging into the mobile app is unrelated to any authentication information associated with the loyalty program account corresponding to the account number provided in third input field 340.

Upon providing the sign-up information, users select sign-up button 350 to register with the mobile app. In an embodiment, the mobile app may send a request to initiate a loyalty program registration process upon determining that no input or improper input has been provided in third input field 340. In an embodiment, the request to initiate the loyalty program registration process is consumed by a loyalty program app residing on mobile device 300. In an embodiment, the request directs a web browser executing on mobile device 300 to specific web content for completing the loyalty program registration process. In an embodiment, the mobile app initiates a profile generation process with a back end server (e.g., backend server 130 of FIG. 1) that provides computing resources to the mobile app.

Through the profile generation process, the mobile app creates an app-related profile for the user providing the sign-up information. In an embodiment, the mobile app initiates a verification process with a loyalty program server (e.g., loyalty program server 120 of FIG. 1) upon selection of sign-up button 350. Through the verification process, the mobile app verifies that the loyalty program account corresponding to the account number entered in third input field 340 belongs to the user providing the sign-up information.

FIG. 4 is an example of an interface 410 displaying a log-in screen associated with a mobile app executing on mobile device 400. Interface 410 enables users to log into the mobile app by providing the authentication information entered while registering with the mobile app. As shown, users are prompted with a first input field 420 for providing an email address and second input field 430 for providing a password. Upon providing the authentication information, users select log-in button 440 to log into the mobile app. Selection of log-in button 440 invokes an authentication process associated with the mobile app.

In an embodiment, the authentication process executes locally on mobile device 400. In an embodiment, the authentication process executes on a server (e.g., loyalty program server 120 or backend server 130 of FIG. 1). In an embodiment, interface 410 also includes one or more input elements selectable by users that forgot the authentication information entered while registering with the mobile app. Upon selection, the one or more input elements of this embodiment initiate an authentication recovery process with a server implementing the authentication process.

In an embodiment, interface 410 includes link 450 for users that have not previously registered with the mobile app. Selection of link 450 causes the mobile app to present an interface displaying a sign-up screen (e.g., interface 310 of FIG. 3). In an embodiment, a portion of interface 410 displays a sign-up screen associated with the mobile app. In this embodiment, interface 410 does not include link 450.

FIG. 5 is an example of an interface 500 displaying a welcome screen (home screen or dashboard) associated with a mobile app executing on mobile device 500. Interface 500 enables users participating in a loyalty program offered by a provider to earn points based, in part, on a current geolocation of mobile device 500. As shown, interface 500 includes a current geolocation field 520 and a destination input field 530 for entering a service location of the provider. Current geolocation field 520 is implemented as an output element to prevent users from modifying the current geolocation of mobile device 500. In an embodiment, the mobile app communicates a search prefix including at least one alphanumeric character entered into destination input field 530 to a search engine process executing on a server (e.g., loyalty program server 120 or backend server 130 of FIG. 1). In this embodiment, the mobile app receives a query suggestion corresponding to a service location of the provider from the server based on the search prefix. In an embodiment, destination input field 530 is implemented as a drop down list that is prepopulated with service locations associated with the provider.

A distance between the current location of mobile device 500 and a geolocation of the service location provided in destination input field 530 is displayed in first output field 540. Second output field 550 displays points offered by the provider for completing a transaction or transaction at the service location provided in destination input field 530 based on the distance displayed in first output field 540. In an embodiment, interface 510 includes input element 560 for initiating a trip to the service location provided in destination input field 530.

Selection of input element 560 causes the mobile app to store the current geolocation of the mobile device. If a user currently logged into the mobile app completes a transaction at the service location, this stored current geolocation is subsequently used in apportioning points to a loyalty program account associated with that user. For example, if the user does complete the transaction, the mobile app may retrieve the stored current geolocation to determine the distance travelled to the service location. In this example, that distance may be determined to be X miles based on the stored current geolocation relative to a geolocation of the service location.

Using an apportioning function, the mobile app may convert that distance of X miles to Y points offered by the provider for completing the transaction. Those Y points may then be applied to a loyalty program account associated to the user. In an embodiment, selection of input element 560 causes the mobile app to submit a request to launch a navigation app residing on mobile device 500. In an embodiment, the mobile device may forward the service location provided in destination input field 530 to the navigation app along with the request. In an embodiment, selection of input element 560 causes the mobile app to transition to a background mode in which the mobile app executes as a background process on mobile device 500.

Summary information for a loyalty program account of a user currently logged into the mobile app is displayed in summary region 570. As shown, the summary information may include such information as an aggregate distance travelled using the mobile app, points apportioned to the loyalty program account based on the aggregate distance travelled. Summary region 570 may further include other information stored in a profile associated with the loyalty account, such as a current points balance, a name of the user, a date the loyalty account was established, and the like. Link 575 enables users to access information regarding past trips taken using the mobile app. In an embodiment, the information regarding past trips may be stored locally on mobile device 500, remotely on a server associated with the mobile app (e.g., loyalty program server 120 or backend server 130 of FIG. 1), or a combination thereof.

In an embodiment, interface 510 also includes one or more input elements selectable by users to enroll in an email referral program associated with the loyalty program. Upon selection, the one or more input elements of this embodiment cause the mobile app to generate a custom network address (e.g., a uniform resource location (“URL”) address) tied to a loyalty program account of a user. The user may forward the custom network address to other users (e.g., friends, family, and the like). When any of those other users sign-up for a loyalty program account via the custom network address, additional points are credited to the loyalty program account of the user enrolling in the email referral program.

In an embodiment, interface 510 also includes one or more input elements selectable by users to enroll in a social media publication program associated with the loyalty program. Upon selection, the one or more input elements of this embodiment cause the mobile app to interface with one or more social media network accounts of the user. Examples of such social media network accounts are provided by Facebook, Inc. of Menio Park, Calif.; Twitter, Inc. of San Francisco, Calif.; and INSTAGRAM. Whenever points are credited to the loyalty account of the user, details about the credited points and related trip are published by the mobile app on one or more social media networks accounts of the user.

In an embodiment, a provider offering a loyalty program may partner with one or more other providers of goods or services (“partner providers”). Such partner providers may sell related goods or services that complement the goods or services sold by the provider offering the loyalty program. For example, if the provider offering the loyalty program is a hotel provider, a partner provider may be an airline partner that sells transportation services to customers of the hotel provider. Partner providers may also sell unrelated goods or services that do not complement the goods or services sold by the provider offering the loyalty program. Using the example where the provider is a hotel provider, a partner provider may be a telecomm provider that sells communication services used by customers of the hotel provider.

In an embodiment, the mobile app may be configured to identify locations of partner providers proximate to mobile device 500. In an embodiment, the mobile app may generate an interface element that notifies users that a location of the partner provider is proximate to mobile device 500. For example, if the partner provider is an energy provider, the mobile app may generate an interface element that notifies users that mobile device 500 is approaching a gas station associated with the energy provider in a specified distance (e.g., 3 miles). In an embodiment, the mobile app may generate an interface element that presents an offer to users related to the partner provider. For example, if the partner provider is an energy provider, the mobile app may generate an interface that offers users a specified number of points for their loyalty program account (e.g., 50 points) if they purchase fuel at the gas station associated with the energy provider.

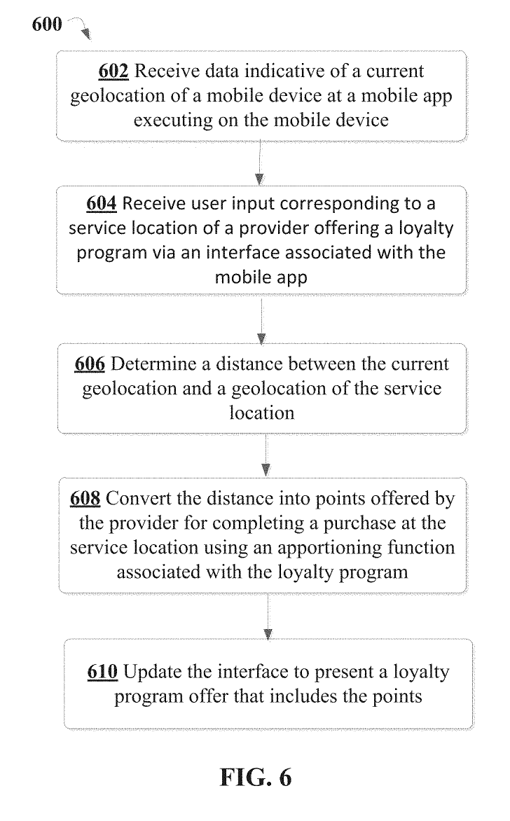

FIG. 6 depicts an embodiment of a method 600 for location-aware apportioning of points in a loyalty program offered by a provider. In an embodiment, method 600 may be effectuated by mobile app 112 of FIG. 1. At block 602, a mobile app executing on a mobile device receives data indicative of a current geolocation of the mobile device. In an embodiment, the mobile app receives the data indicative of the current geolocation from a navigational app residing on the mobile device. In an embodiment, the data indicative of the current geolocation is global positioning system (“GPS”) data, Wi-Fi data, cellular network triangulation data, or a combination thereof.

At block 604, the mobile app receives user input corresponding to a service location of the provider via an interface associated with the mobile app. At block 606, a distance between the current geolocation and a geolocation of the service location is determined. In an embodiment, the distance is determined by forwarding the data indicative of the current geolocation and the user input corresponding to the service location a navigational app residing on the mobile device.

At block 608, the distance is converted into points offered by the provider for completing a transaction at the service location using an apportioning function associated with the loyalty program. In an embodiment, the apportioning function is one of a plurality of apportioning functions associated with the loyalty program. In an embodiment, the apportioning function is selected from among a plurality of apportioning functions based on authentication information received via the interface during an authentication process. At block 610, the mobile app updates the interface to present a loyalty program offer that includes the points. In an embodiment, the loyalty program offer is implemented using an interface element.

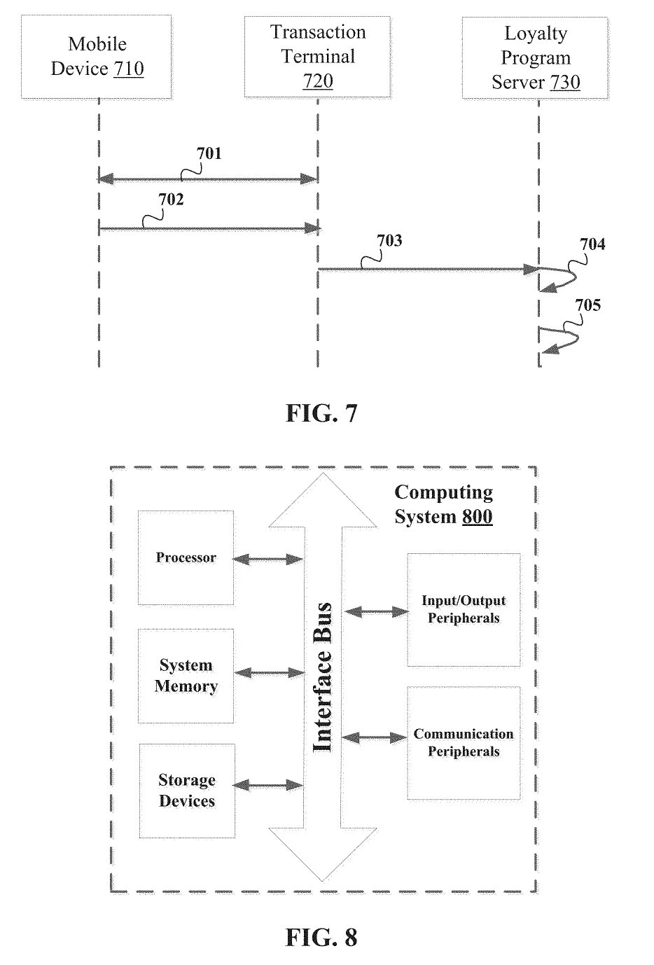

FIG. 7 is a flow diagram depicting an example process 700 for confirm or verify completion of transactions associated with loyalty program offers, and accordingly apportioning points to loyalty program accounts. At step 701, a communication link is established between a mobile application executing on a mobile device 710 and a transaction terminal 720 located at a service location of a provider offering a loyalty program. The communication link is established at step 701 while a transaction associated with a loyalty program offer is being effectuated. In an embodiment, mobile device 710 and transaction terminal 720 are implemented using mobile device 110 and transaction terminal 140 of FIG. 1, respectively. In an embodiment, mobile device 710 initiates the establishment of the communication link. In an embodiment, transaction terminal 720 initiates the establishment of the communication link.

At step 702, transaction terminal 720 receives data indicative of the loyalty program offer from the mobile application executing on mobile device 710 using the communication link. In an embodiment, the data indicative of the loyalty program offer includes authentication information received by the mobile application as part of an authentication process. In an embodiment, the data indicative of the loyalty program offer includes a distance travelled by a user of mobile device 710 to complete the transaction. In an embodiment, the distance corresponds to the distance described above with respect to block 606 of FIG. 6.

At step 703, transaction terminal 720 transmits a notification to loyalty program server 730 to confirm completion of the transaction associated with the loyalty program offer. In an embodiment, loyalty program server 730 is implemented using loyalty program server 120 of FIG. 1. At step 704, loyalty program server 730 identifies a loyalty program account corresponding to a user of mobile device 710 based on authentication information included in the notification received in step 703. At step 705, loyalty program server 730 apportions points to the loyalty program account based on a distance travelled by the user of mobile device 710 to complete the transaction.

In an embodiment, loyalty program server 730 obtains the distance travelled by the user of mobile device 710 to complete the transaction from the notification received in step 703. In an embodiment, loyalty program server 730 independently determines the distance travelled by the user of mobile device 710 to complete the transaction. In this embodiment, the notification received in step 703 includes a current geolocation of mobile device 710 when initiating a trip to the service location at which transaction terminal 720 is located. Loyalty program server 730 independently determines the distance using that current geolocation and a geolocation of the service location at which transaction terminal 720 is located. In an embodiment, the notification received in step 703 includes data indicative the geolocation of the service location at which transaction terminal 720 is located. In an embodiment, the notification received in step 703 includes identifying information for the service location at which transaction terminal 720 is located.

In an embodiment, loyalty program server 730 updates a profile associated with the loyalty program account with details about the points and the transaction. In an embodiment, the mobile application executing on mobile device 710 publishes the details about the points and the transaction on a social media network account of the user. In an embodiment, the mobile application executing on mobile device 710 receives the details about the points and the transaction in a push notification communicated by loyalty program server 730. In an embodiment, the mobile application executing on mobile device 710 receives the details about the points and the transaction by accessing the profile associated with the loyalty program account.

Having described various embodiments of the invention, an exemplary computing system suitable for implementing embodiments of the invention is now described. With reference to FIG. 8, mobile device 110, loyalty program server 120, backend server 130, and transaction terminal 140 may be implemented on one or more computer devices or systems, such as exemplary computer system 800. In a basic configuration, the computing system may include at least a processor, a system memory, a storage device, input/output peripherals, communication peripherals, and an interface bus. Instructions stored in the memory may be executed by the processor to perform a variety of methods and operations, including the location-aware apportioning of points in a loyalty program offered by a provider, as described above. The computing system components may be present in a client device executing a client application for interacting with one or more components of a distributed computing network, in a server or other component of the distributed computing network, or distributed between some combination of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system. This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a WiFi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

In general, the routines executed to implement the embodiments of the invention, whether implemented as part of an operating system or a specific application, component, program, object, module or sequence of instructions, or even a subset thereof, may be referred to herein as “computer program code,” or simply “program code.” Program code typically comprises computer readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer readable program instructions for carrying out operations of the embodiments of the invention may be, for example, assembly language or either source code or object code written in any combination of one or more programming languages.

The program code embodied in any of the applications/modules described herein is capable of being individually or collectively distributed as a program product in a variety of different forms. In particular, the program code may be distributed using a computer readable storage medium having computer readable program instructions thereon for causing a processor to carry out aspects of the embodiments of the invention.

Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include random access memory (RAM), read-only memory (ROM), erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer readable storage medium should not be construed as transitory signals per se (e.g., radio waves or other propagating electromagnetic waves, electromagnetic waves propagating through a transmission media such as a waveguide, or electrical signals transmitted through a wire). Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions/acts specified in the flowcharts, sequence diagrams, and/or block diagrams. The computer program instructions may be provided to one or more processors of a general purpose computer, special purpose computer, or other programmable data processing apparatus to produce a machine, such that the instructions, which execute via the one or more processors, cause a series of computations to be performed to implement the functions and/or acts specified in the flowcharts, sequence diagrams, and/or block diagrams.

In certain alternative embodiments, the functions and/or acts specified in the flowcharts, sequence diagrams, and/or block diagrams may be re-ordered, processed serially, and/or processed concurrently without departing from the scope of the embodiments of the invention. Moreover, any of the flowcharts, sequence diagrams, and/or block diagrams may include more or fewer blocks than those illustrated consistent with embodiments of the invention.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “or” as used herein refers to and encompasses any and all possible combinations of one or more of the associated listed items. It will be further understood that the terms “comprises” or “comprising,” when used in this specification, specify the presence of stated features, integers, steps, operations, elements, or components, but do not preclude the presence or addition of one or more other features, integers, steps, operations, elements, components, or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed:

1. A method comprising:
receiving, at a mobile application executing on a mobile device, data indicative of a current geolocation of the mobile device;
receiving, via an interface associated with the mobile application, input corresponding to a service location of a provider offering a loyalty program;
determining a distance between the current geolocation and a geolocation of the service location;
converting the distance into points offered by the provider for completing a transaction at the service location using an apportioning function associated with the loyalty program; and
updating the interface to present a loyalty program offer that includes the points.

2. The method of claim 1, wherein a server-side component of the mobile application converts the distance into the points offered by the provider for completing the transaction.

3. The method of claim 1, wherein the apportioning function is selected from among a plurality of apportioning functions associated with the loyalty program based on authentication information received via the interface during an authentication process.

4. The method of claim 1, wherein the data indicative of the current geolocation is received from a navigational application residing on the mobile device.

5. The method of claim 1, wherein the data indicative of the current geolocation includes global positioning system data, Wi-Fi data, cellular network triangulation data, or a combination thereof.

6. The method of claim 1, further comprising:
communicating data indicative of the loyalty program offer to a transaction terminal while effectuating the transaction at the service location.

7. The method of claim 6, wherein the transaction terminal is configured to transmit a notification to a loyalty program server to confirm completion of the transaction thereby causing the loyalty program server to apportion the points to a loyalty program account associated with a user of the mobile device.

8. The method of claim 1, wherein the input corresponding to the service location is a first input, and the method further comprising:
receiving a second input representing a selection of an interface element of the interface for initiating a trip to the service location.

9. The method of claim 8, further comprising:
in accordance with receiving the second input, storing the current geolocation of the mobile device such that a user of the mobile application is unable to modify the current geolocation.

10. The method of claim 8, further comprising:
in accordance with receiving the second input, transitioning the mobile application to a background mode in which the mobile application executes as a background process on the mobile device.

11. The method of claim 8, further comprising:
in accordance with receiving the second input, launching a navigation application residing on the mobile device and forwarding the service location to the navigation application.

12. The method of claim 1, further comprising:
identifying a location of a partner provider within a defined proximity of the mobile device while transiting between the current geolocation and the geolocation of the service location.

13. The method of claim 1, further comprising:
presenting an interface element on the interface that indicates a location of a partner provider is within a defined proximity of the mobile device.

14. The method of claim 13, wherein the interface element includes an offer for a specified number of loyalty program points for purchasing a good or service at the location of the partner provider.

15. A system comprising:
a transaction terminal located at a service location of a provider offering a loyalty program;
a processor; and
a computer-readable storage medium comprising instructions that upon execution by the processor cause the system to perform operations, the operations comprising:
establishing a communication link between the transaction terminal and a mobile application executing on a mobile device while effectuating a transaction associated with a loyalty program offer;
receiving, at the transaction terminal, data indicative of the loyalty program offer from the mobile application using the communication link; and
transmitting a notification to a loyalty program server to confirm completion of the transaction thereby causing the loyalty program server to apportion points to a loyalty program account associated with a user of the mobile device, the points based on a distance travelled by a user of the mobile device to complete the transaction.

16. The system of claim 15, wherein the distance travelled by the user of the mobile device to complete the transaction is defined by a current geolocation of the mobile device when initiating a trip to the service location and a geolocation of the service location.

17. The system of claim 15, wherein the data indicative of the loyalty program offer includes authentication information received by the mobile application as part of an authentication process, and wherein the loyalty program server is configured to identify the loyalty program account based on the authentication information.

18. A non-transitory computer-readable storage medium, storing program instructions computer-executable on a computer to perform operations comprising:
at a loyalty program server supporting a loyalty program offered by a provider:
receive a notification from a transaction terminal located at a service location of a provider offering a loyalty program, the notification including data indicative of a loyalty program offer that the transaction terminal received from a mobile application while effectuating a transaction associated with the loyalty program offer;
identify a loyalty program account corresponding to a user of the mobile device based on authentication information included in the notification; and
apportion points to the loyalty program account based on a distance travelled by the user of the mobile device to complete the transaction.

19. The non-transitory computer-readable storage medium of claim 18, wherein the program instructions are computer-executable on the computer to:
update a profile associated with the loyalty program account with details about the points and the transaction.

20. The non-transitory computer-readable storage medium of claim 19, wherein the mobile application publishes the details about the points and the transaction on a social media network account of the user.
